(19) United States
(12) Patent Application Publication
(10) Pub. No.: US 2007/0094638 A1
(43) Pub. Date: Apr. 26, 2007

(54) Systems and methods for creating reusable software components based on regulatory and policy documents to ensure compliance with the documents for integration with automated systems

(76) Inventors: Stephen F. DeAngelis, Washington Crossing, PA (US); Frederick W. Stangl, Langhorne, PA (US); Rob J. Toole, Bala Cynwyd, PA (US); Doug J. Todd, Gwynedd Valley, PA (US)

Correspondence Address: KIRKPATRICK & LOCKHART PRESTON GATES ELLIS LLP, 535 SMITHFIELD STREET, PITTSBURGH, PA, 15222, US

(21) Appl. No.: 11/255,749

(22) Filed: Oct. 21, 2005

(51) Int. Cl. G06F 9/44

(52) U.S. Cl. 717/107

(57) ABSTRACT

A computer-assisted method for generating one or more reusable software components that can be invoked by an automated business process to make the automated business process compliant with a regulation is disclosed. According to various embodiments, the method includes the step of analyzing a document containing the regulation to extract use case information and business rules for a sub-process that complies with the regulation. The method may also include the step of developing the reusable software component for the sub-process based on the use case information and business rules. The method may further include the step of storing the reusable software component in a repository such that the reusable software component is invokable by the automated business process.

### BACKGROUND

Many businesses automate business processes such that they can be implemented using web services. For example, BPEL (Business Process Execution Language) is an XML-based language designed to enable process management and task-sharing for a distributed computing or grid computing environment—even across multiple organizations—using a combination of web services and process logic. Using BPEL, a programmer formally describes a business process that will take place across the web or http communication link in such a way that any cooperating entity can perform one or more steps in the process the same way. In a supply chain process, for example, a BPEL program might describe a business protocol that formalizes what pieces of information a product order consists of, and what exceptions may have to be handled. The BPEL program would not, however, specify how a given web service should process a given order internally.

Government statutes and regulations often require businesses to perform certain functions and processes as part of their business. For example, the U.S. Patriot Act requires financial institutions to consult lists of known or suspected terrorist to determine whether a person seeking to open an account appears on such lists. Currently, implementation of such business process requirements is done manually on an ad hoc basis by adding process steps to existing web service business process routines to ensure compliance. This process is cumbersome and expensive.

### SUMMARY

In one general aspect, the present invention is directed to a computer-assisted method for generating one or more reusable software components that can be invoked by an automated business process to make the automated business process compliant with a regulation. The regulation may be, for example, a government regulation, statute, ordinance or law, or a business policy. The method may include the step of analyzing a document containing the regulation to extract use case information and business rules for a sub-process that complies with the regulation. The method may also include the step of developing the reusable software component for the sub-process based on the use case information and business rules. In addition, the method may include the step of storing the reusable software component in a repository such that the reusable software component is invokable by the automated business process. In that way, the reusable software components stored in the library can be integrated into the automated business process of an enterprise or business in a way that makes the process compliant with the regulation by design. One possible benefit of this approach is that compliance monitoring and exception handling can be performed in real time. Another potential benefit is that the software components in the repository (or library) may be updated or refreshed as changes to the regulation occur to assure continuing compliance. Both of these factors contribute to enterprise resilience.

According to various implementations, the above-described method may further comprising the steps of identifying one or more object classes for the sub-process and generating one or more activity diagrams for the sub-process. Also, the method may include the step of generating one or more class diagrams for the sub-process. The reusable software component may be developed based on the object classes, the activity diagrams and/or the class diagrams. The method may also comprise developing user interfaces for the sub-process.

In addition, the step of developing the reusable software component may includes the steps of (i) identifying partner links to access external processes and data sources, (ii) identifying message structures (e.g., SOAP message structures) to define input and output documents for the reusable software component, and (iii) creating steps for carrying out the sub-process. The developed software component may also include web services interfaces. Also, the step of analyzing the document may include identifying operational impacts and organizational impacts on an enterprise imposed by the regulation.

According to another general embodiment, the computer-assisted process for generating the reusable software components comprises: (i) analyzing a document containing the regulation to identify process flows and rule logic for a sub-process that complies with the regulation; (ii) developing the reusable software component for the sub-process based on the use case information and business rules; and (iii) storing the reusable software component in a repository such that the reusable software component is invokable by the automated business process. According to various implementations, the process may further comprise modeling the process flows using semantic analysis modeling tool and/or modeling the rule logic using a semantic analysis rules engine tool. Also, the process may further comprise determining integration points for the sub-process and/or identifying security requirements for the sub-process.

In another general aspect, the present invention is directed to an automated business system. According to various embodiments, the automated business system includes the repository which stores the reusable software components, where each reusable software component includes code for implementing performance of a sub-process to comply with one or more regulations. The automated business system may also include a business process engine for executing a business process routine (e.g., a BPEL code) that invokes the reusable software components. Additionally, the automated business system may comprise a rules engine in communication with the business process engine and the repository for calling the reusable software component from the repository when requested by the business process engine and delivering the requested software components to the business process engine for execution.

In another general aspect, embodiments of the present invention are directed to a computer system for generating the reusable software components. According to various embodiments, the computer system may comprise: a modeling module for identifying and creating object classes for a sub-process that complies with the regulation; a semantics analysis module for generating one or more activity diagrams for the sub-process; and a business process code generator module for generating business process code for the sub-process based on the object classes and the one or more activity diagrams.

These and other features of the present invention will be apparent from the description below.

### FIGURES

Embodiments of the present invention are described herein by way of example in conjunction with the following figures, wherein:

FIGS. 1-3 are flowcharts illustrating the processes according to various embodiments of the present invention;

FIG. 4 is a diagram of a computer system that may be used in the development of the reusable software components according to various embodiments of the present invention;

FIG. 5 is an example activity diagram;

FIG. 6 is a diagram of an automated business system according to various embodiments of the present invention;

FIG. 7 is a diagram of a process for developing a resilient business process according to various embodiments of the present invention;

FIG. 8 is a diagram of a data model according to various embodiments of the present invention;

FIG. 9 shows screen shots of electronic templates an end user may use to model a document according to various embodiments of the present invention;

FIG. 10 shows an example of the mapping of the data for a document according to the data mode of FIG. 8; and

FIG. 11 is a flowchart according to another embodiment of the present invention.

### DETAILED DESCRIPTION

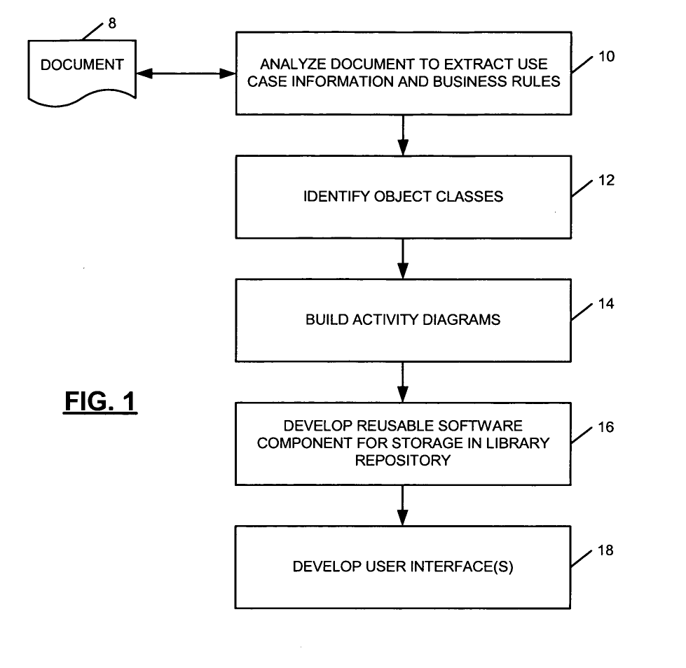

Various embodiments of the present invention are directed to computer-assisted methods and computer systems for generating reusable software components (or “modules”) based on, for example, a regulatory or policy document(s) to ensure compliance with the document for integration into automated business processes performed by a business or other type of enterprise. With reference to FIG. 1, the document 8 may contain the regulations that are subject to the process. The regulations may be government regulations or ordinances (e.g., federal, state, local, etc.) that pertain to the business. For example, where the business is a financial institution, the document 8 may contain government regulations that pertain to the process of opening an account for a customer. As mentioned before, the U.S. Patriot Act requires financial institutions to consult lists of known or suspected terrorist to determine whether a person seeking to open an account appears on such lists. Thus, a document containing the regulatory requirements of the U.S. Patriot Act could be an example of the document 8. That document 8 would then be used, as described in more detail below, to generate one or more reusable software components that would ensure compliance with the requirements of the U.S. Patriot Act and that could be invoked in the normal business process of the regulated entity (e.g., a financial institution). The document 8 may also (either alternatively or additionally) include policy requirements, such as internal operating procedures, best practices for the business/enterprise, corporate governance policies, contingency plans, etc. As used herein, unless otherwise noted, the term “regulation” is used to refer to such government laws, statutes, regulation and ordinances, and to business/enterprise policies.

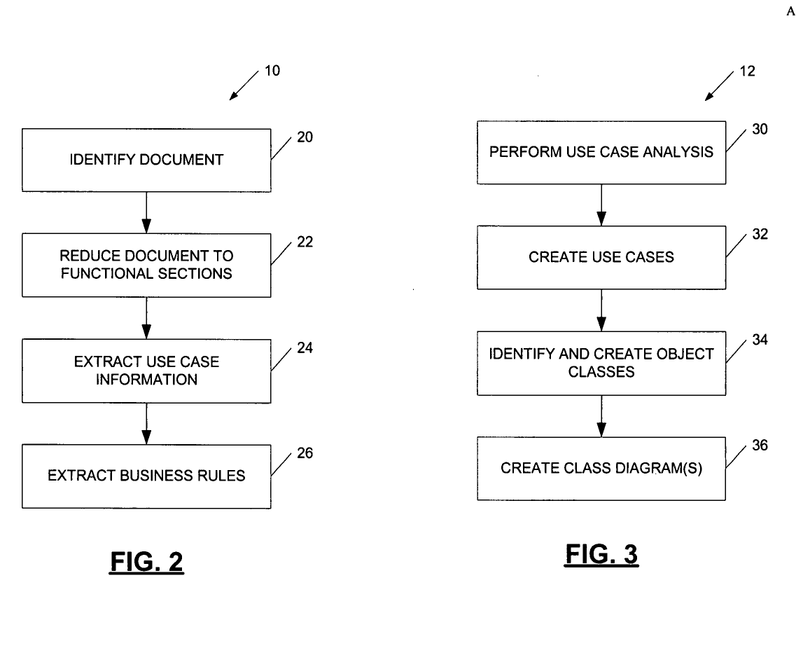

At step 10, the document 8 is analyzed to extract or derive the use case information and business rules for the regulation or regulations contained therein. FIG. 2 is a diagram of a process for performing step 10 according to various embodiments. At step 20, the document 8 is analyzed to identify whether it is, for example, a document containing government (e.g., federal, state and/or local) regulations, statutes or ordinances, or whether the document contains policies of the business (e.g., corporate governance policies). The document 8 could, in other embodiments, contain other types of regulations pertaining to the enterprise/business.

Next, at step 22, the document 8 is analyzed in order to reduce it to functional sections. This step may be performed with the aid of one or more subject matter experts (“SME”) in the field to which the document pertains (e.g., a lawyer, a financial advisor, a security expert, a human resources expert, an industry expert, etc.). This step 22 may involve identifying the operational impacts on the business to determine where activities and rules are applied. The step 22 may also involve identifying the organizational impacts on the business to determine, for example, where manual steps are required (including by specific job position or role).

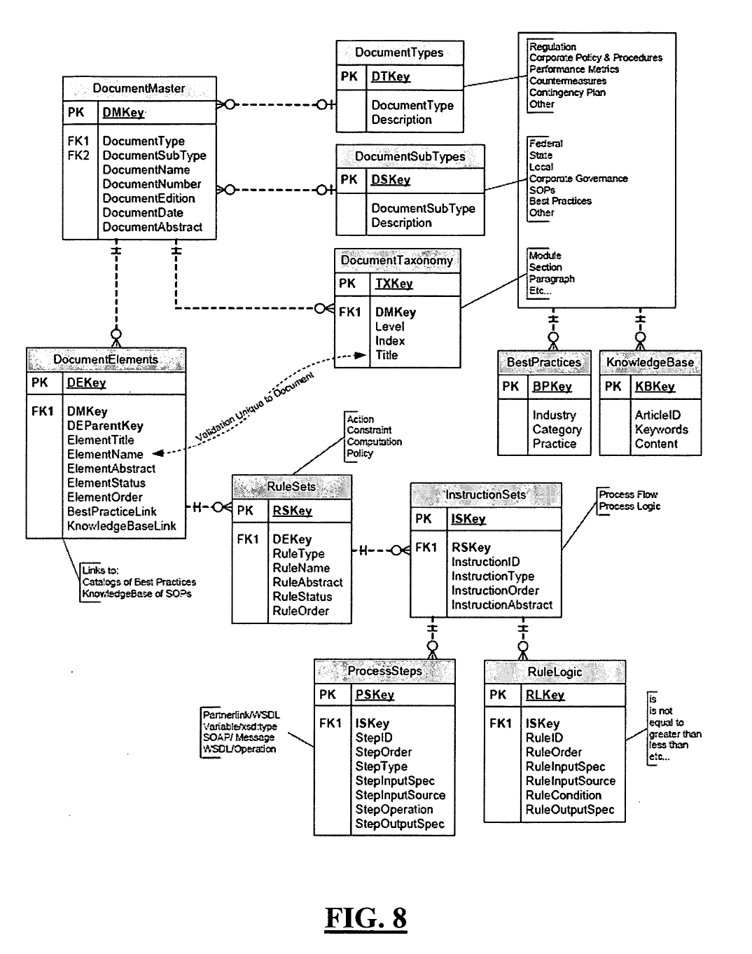

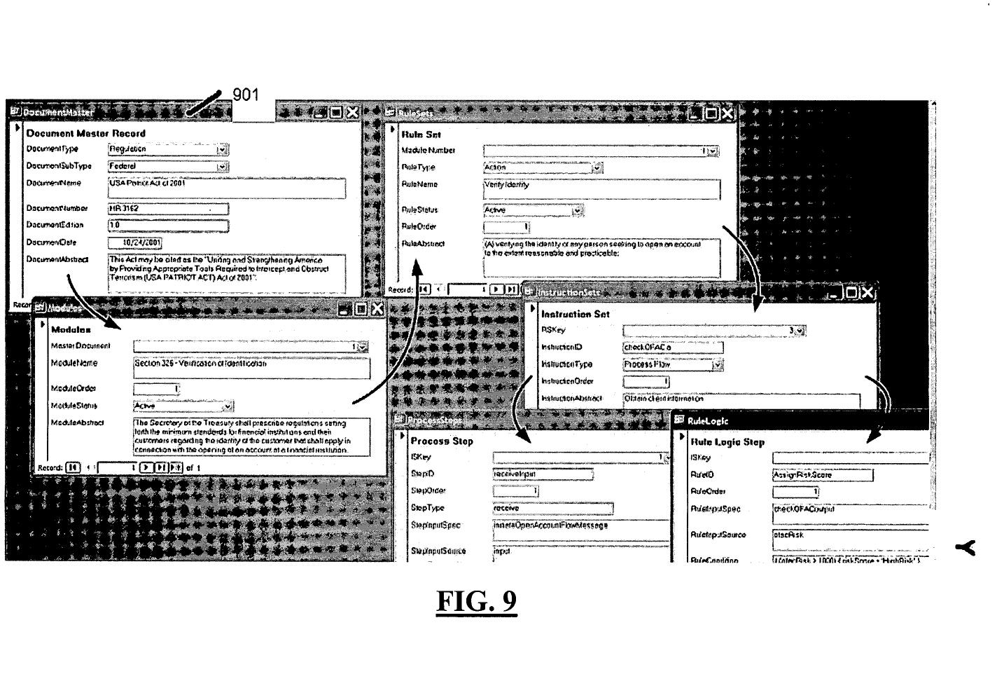

In various embodiments, pre-defined document-based (electronic and/or hard copy) templates and worksheets may be used to extract and break down the information in the document 8 to facilitate the analysis. FIG. 8 is a diagram of a data model that may be used to model the document. As can be seen in the exemplary data model, the model may model the document according to document types, sub-types, taxonomy, document master, document elements, rule sets, instruction sets, process steps and rule logic. FIG. 9 contains a series of screen shots that an end-user may use to model the document according to the data model. As can be seen in the example of FIG. 9, separate windows may allow the end-user to enter the data for the various parameters in the model. For example, in the “Document Master” window 901, the use may enter the document type and sub-type, the document name and number, the document edition, the document data, the abstract, etc.

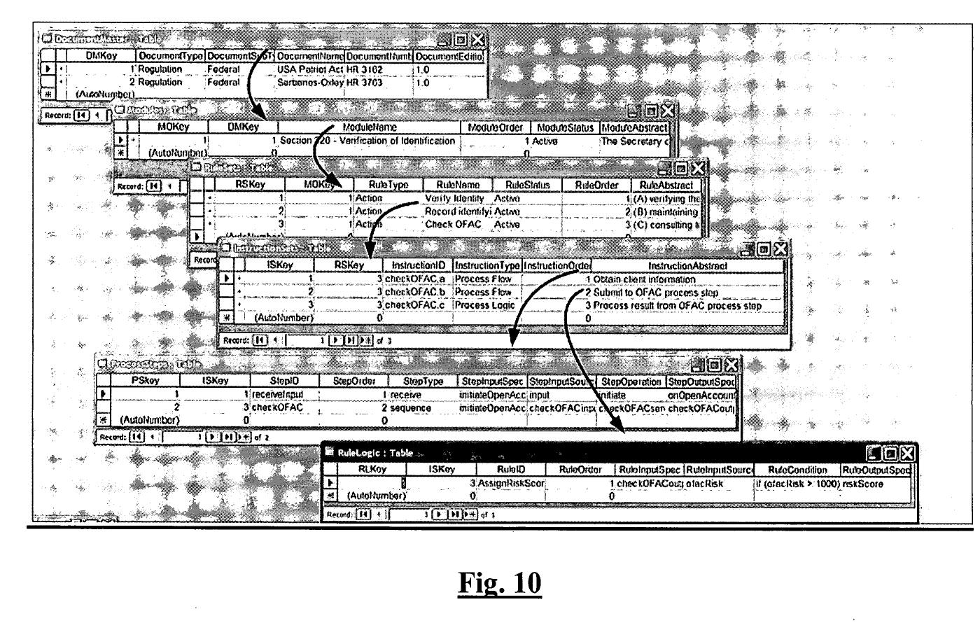

FIG. 10 provides an example of how the modeling data may be linked in a database storing the modeling data. As can be seen in the example of FIG. 10 (and in accordance with the exemplary data model of FIG. 8), the document master data may map to the module data, which may map top the rule set data for the document, which in turn may map to the instruction set data, which may map to the process step and the rule logic.

Returning to FIG. 2, next at step 24, use case information (e.g., steps and procedures) for the document 8 is extracted. For example, the SME(s) may sort out the required business steps the business/enterprise must perform to be in compliance with the regulations in the document 8. These steps are preferably broken down to the lowest meaningful level or granularity possible and may be organized in sequence. The following elements may be identified in the process: the actors (the persons or systems carrying out the step or procedure); the actions (the event or result effected by the actor); and the objects (the target of the event or result effected by the author). From this breakdown analysis, the steps or procedures to ensure compliance with the regulations may be sequenced and organized by those that require manual intervention and those that can be automated. In the process, opportunities for business process automation (e.g., BPEL) may be identified.

Next, at step 26, applicable business rules for the regulations in the document 8 are extracted. That is, for example, the business rules or decision points a business must apply to be in compliance with the regulations of the document 8 may be identified. These rules are preferably broken down to their lowest meaningful level of granularity possible and are organized in sequence with the following elements identified: the facts (e.g., the description of the object to be subjected to the rule); the properties (e.g., a list of data elements and attributes that are needed by the rule); and decisions (e.g., the description of the logic to be applied to enforce the rule). From this analysis, the rules required in order to ensure compliance with the regulations may be sequenced and organized by those that require manual intervention and those that can be automated. As a result, opportunities for business process automation (e.g., BPEL) may be identified.

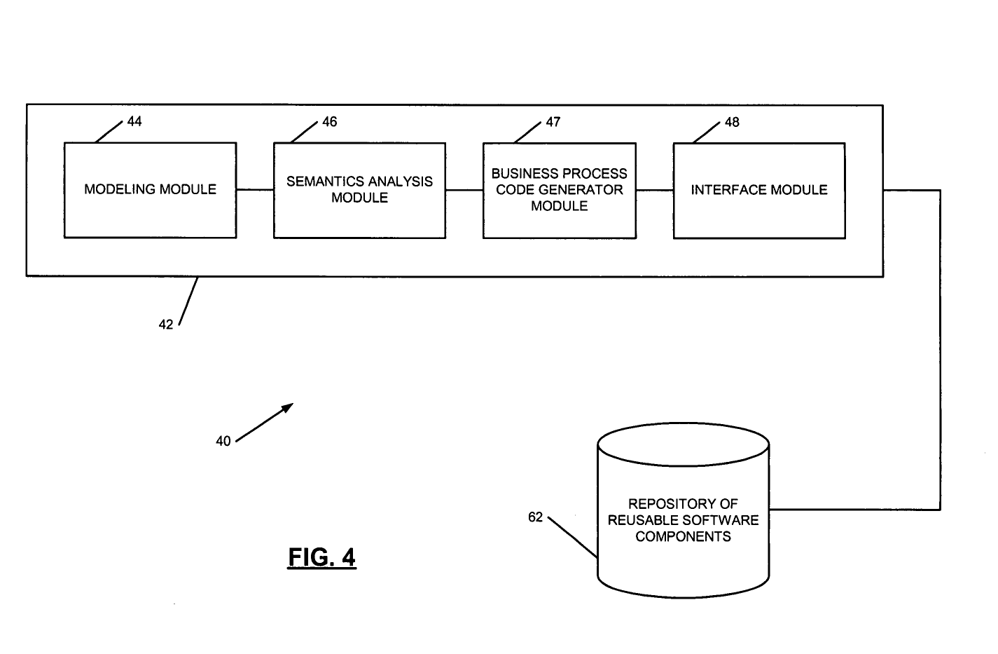

Returning to FIG. 1, at step 12 object classes for the various steps of the sub-process (or sub-processes) to ensure compliance with the regulations in the document 8 are identified. The term “sub-process” is used to refer to the process implemented by the reusable software component because the software component may be invoked by an automated business process. FIG. 3 is a diagram of a process for performing step 12 according to various embodiments. At step 30, a use case analysis is performed. This may include (1) determining the start and end states of the sub-process and (2) identifying business activities and rules. Next, at step 32, use cases for the sub-process(es) are created. Next, at step 34, the object classes for the sub-process(es) may be identified and created. This step may involve identifying the class data elements and class methods for each class definition created at step 32. At step 36, class diagrams for the sub-process(es) may be created.

Step 12 of FIG. 1, as well as other steps described herein, may be implemented using a computer system. FIG. 4 is a diagram of a computer system 40 for assisting the process of generating the reusable software components according to various embodiments of the present invention. The computer system 40 may include one or a number of networked computer devices 42 (e.g., PCs, workstations, servers, etc). The computer device(s) 42 may include a number of modules 44, 46, 47, 48, the functions of which are further described below. The modules 44, 46, 47, 48 may be implemented as software code to be executed by a processor of the computer device 42 using any suitable computer instruction type. The software code may be stored as a series of instructions or commands, or as a program, on a computer readable medium.

The modeling module 44 may be used to aid the performance of step 12. According to various embodiments, the modeling module 44 may be implemented using a UML (Unified Modeling Language) modeling software tool, such as N8 or IBM Rational Rose. As such, at step 32 the modeling module 44 may, for example, instantiate the use cases for the sub-process(es) in UML modeling software. At step 34 the modeling module 44 may similarly identify and create the object classes necessary to define the players and targets for each use case using standards-based UML software and, at step 36, create the class diagrams for the sub-process(es).

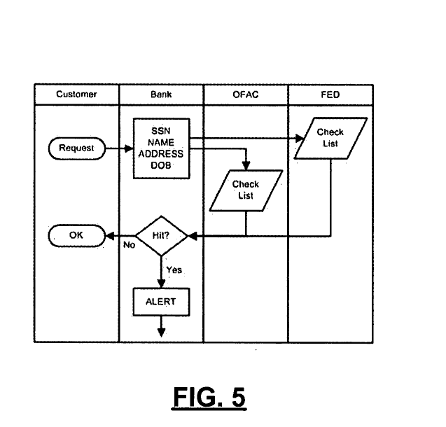

Returning to FIG. 1, at step 14 activity diagrams for the sub-process(es) are created based on the uses cases and object classes previously defined. The activity diagrams model the activity (workflow) between the related use cases. FIG. 5 is an example of an activity diagram for the example of setting up an account for a customer at a financial institution (e.g., a bank) in view of the Patriot Act requirements to consult lists of known or suspected terrorists. In this example, the object classes are the customer, the financial institution (“Bank”), OFAC (Office of Foreign Assets Control) and an appropriate agency of the federal government (“FED”) for an anti-money laundering check. With reference to FIG. 4, a semantics analysis module 46 of the computer device 42 may be used to perform this step. The semantics analysis module 46 may receive the relevant use cases and object classes from the business process modeling module 42 via an interface between the two modules, such as an XMI (XML Metadata Interchange) interface. The activity diagram(s) may be stored and/or exported by the semantics analysis module 46 in a standard format (such as, e.g., an XML format) for further processing and conversion into business process language code (such as, e.g., BPEL code).

Returning again to FIG. 1, at step 16 a reusable software component for implementing the compliant sub-process(es) for integration into the automated business process is generated based on the previously defined activity diagram(s), use cases and/or object classes. In various embodiments, this may comprise at least two steps.

First, business process code (e.g., BPEL) is developed for the sub-processes defined in the previous steps. The process of developing the code may include, in various embodiments, (1) identifying partner links to access external processes and data sources, (2) identifying SOAP message structures to define the input and output documents (objects), (3) creating process steps, e.g., logic sequences for carrying out the business activity, and (4) creating SOAP WSDL interfaces. Second, self-contained rule sets may be created in support of the process automation requirements of the sub-process(es). These rule sets may be written in, for example, XML, JAVA or any other appropriate format. Thus, rules for coding from the analysis of the previous steps may be identified, the rule sets may be created in the appropriate format/language as required by the rules engine, and access methods may be created as needed for integration of the rule sets into automated business processes.

According to various embodiments, once all of the software components required by the regulations of the document 8 have developed, tested and subjected to quality assurance testing, the corresponding code may be packaged into a format that is easily identifiable, accessible, reusable and deployable by an automated business system. The reusable software components may then be stored in a repository or library 62 (e.g., a database).

With reference to FIG. 4, the software developer(s) generating the reusable software component(s) may be aided by the use a business process code (e.g., BPEL) generator module 47 and an interface module 48. The business process code generator module 47 may generate business process code (e.g., BPEL code) based on the previously generated class and activity diagrams. The interface module 48 may be specifically designed to facilitate the generation and packaging of the reusable software component(s).

At step 18, user interfaces to be used with the workflow steps of the reusable software components may be generated as needed. The user interfaces may be created using rich internet application platforms, such as Macromedia Flex. Preferably the user interfaces are created as data-driven code modules that can be reconfigured by the user to meet changing needs.

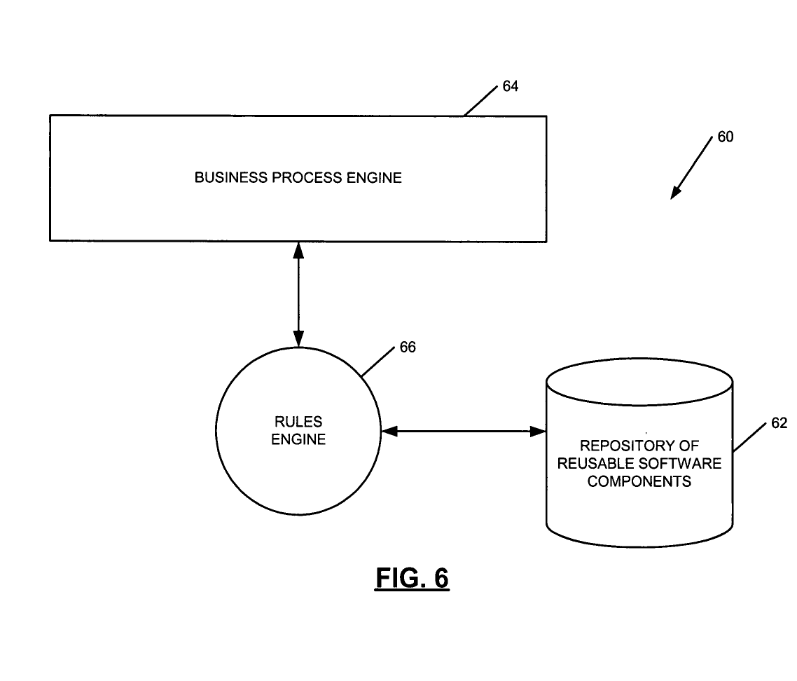

FIG. 6 shows a automated business system 60 in which the reusable software components could be integrated in the automated business process performed by the system to ensure ongoing compliance with the regulations of the document 8 (and/or other regulation containing documents) according to various embodiments. The reusable software components are stored in the repository or library 62. The system may utilize an XML-based service oriented architecture (SOA) using industry-standards business process execution language (BPEL), business rules management systems (BRMS) and web services interfaces. A business process engine 64 may execute the automated business processes of the enterprise/business. According to various embodiments, the business process engine 64 may be a commercially available BPEL Process Management software product. The business process code executed by the business process engine 64 (e.g., BPEL code) may invoke a particular reusable software component that is stored in the repository 62 and that is needed for the execution of the business process by the business process engine 64. In response to the invocation, a rules engine 66 may retrieve the appropriate software component from the repository 62 and deliver it to the business process engine 62 for execution. The rules engine 66 may be, for example, a commercially available Rules Management software product. By storing the reusable software components in the repository 62, as opposed to hard coding the process into the business process code executed by the business process engine 64, the repository 62 can be updated and refreshed as warranted to ensure continuing compliance with the regulations/policies of the document 8.

According to various embodiments, the business process code executed by the business process engine 64 may be code engineered for resilience, in terms of both compliance and vulnerability risks. Methods for generating such resilient business processes are described in the following published United States patent applications, which are incorporated herein by reference: Pub. No. 2005/0065941, Pub. No. 2005/0065904 and Pub. No. 2005/0065807.

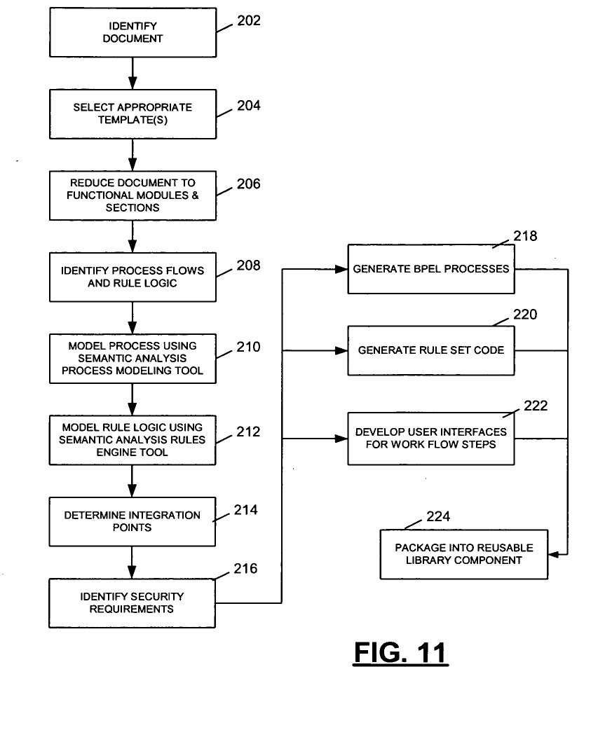

Various steps in the above-described processes may be performed in various orders. For example, FIG. 11 is a diagram of the process flow according to another embodiment of the present invention. At step 202, the document is identified and at step 204 the appropriate templates for modeling the document are selected. The appropriate templates may be selected based on the type of document and the type of subject matter expert required to break down the document, such as, for example, a lawyer, a financial advisor, a security expert, a human resources expert, an industry expert, etc.

Next at step 206, the templates may be used to reduce the document to its functional modules and sections. This may include, for example, identifying operational impacts for process modeling and identifying organizational impacts for workflow modeling. Further, this step may include identifying links to catalogs of best practices (e.g., a database) and links to a knowledge base (e.g., a database) of SOPs and solutions. In that way, strategic links may be placed to associate any level of the document in the hierarchy with the catalog of best practices, and the knowledge base of SOPs and known solutions

Next, at step 208, the process flows and rule logic required by the document may be identified. This may include identifying opportunities for business process automation and for rules automation.

Next, at step 210, the process step may be loaded into a semantic analysis process modeling tool, such as modeling module 44 of system 40 of FIG. 4. The modeling module 44 may determine process start and end states, verify business activities and workflows, develop activity diagrams, and verify activity diagrams and use case definitions. At step 212, the rule logic information may be loaded into a semantic analysis rules engine tool, such as the semantics analysis module 46. The semantics analysis module 46 may, for example, verify the business rules and logic design, identify and create object classes, identify class data elements, and identify class methods.

Next, at step 214, integration points for the process may be identified. This may include identify sources of input data (e.g., web services, remote objects, JCA (Java connection architecture), etc.). Also, SOA (service oriented architecture) web services for output requirements may be created. At step 216, SOA security requirements may be identified. This step may include identify security technologies that can be applied (e.g., SAML (Security Assertions Markup Language), WS-Sec, integrated security, etc.). Also, SOA security models and specifications may be created.

Next, at step 218, business process (e.g., BPEL) processes may be developed. As explained above, this may include identifying partner links, identifying SOAP message structures, creating process steps, and creating SOAP WSDL interfaces. At step 220, rule sets may be developed. As explained above, this step may include identifying rules for coding, creating rule sets in, for example, XML and/or Java format, and creating access methods. At step 222, user interfaces for various workflow steps may be developed. This may include identifying workflow steps user interface requirements, identifying dashboard and process control user interface requirements, creating interfaces in, for example, rich internet application format, and creating process links to integrate user interface components. Then, at step 224, the components may be package into a reusable code library, such as repository 62, for invocation into a business process application.

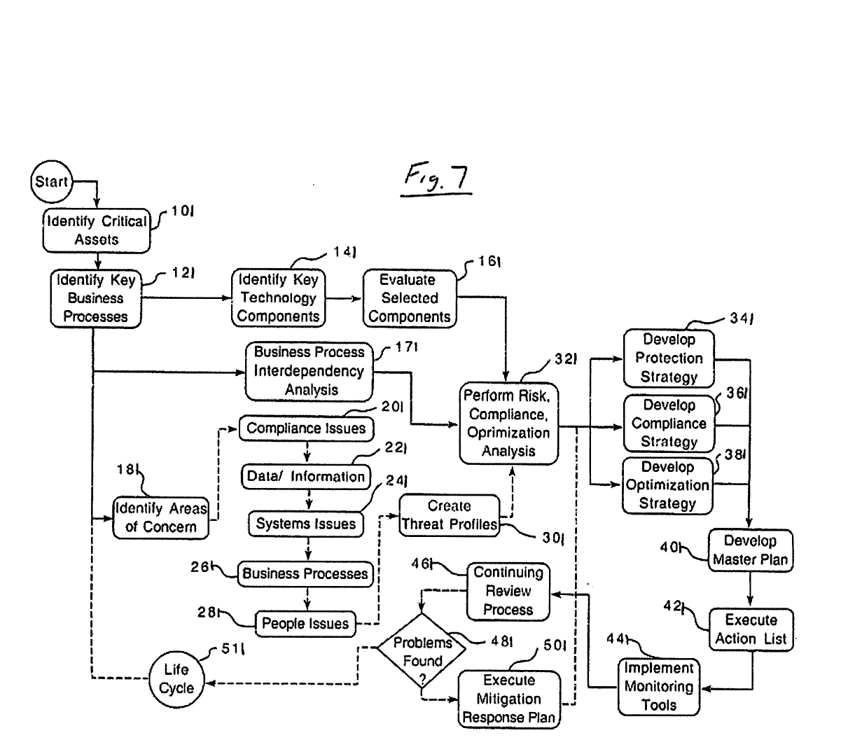

FIG. 7 is an overview of the process for optimizing a business process of an enterprise for resilience, such as a business or government entity, according to various embodiments of the present invention. The process starts at step 101, with the identification of critical assets of the enterprise. This may be performed by a review of the enterprise's functions and assets, including interviews with its employees and principles. For example, if the enterprise is a bank, a critical asset may be a customer. According to various embodiments, the technique used by OCTAVE® (Operationally Critical Threat, Asset, and Vulnerability Evaluation^{SM}) to identity critical assets of the enterprise may be employed. After the critical assets have been identified, the process advances to step 121, where key business processes of the enterprise associated with the identified critical assets are identified. For the banking example, a key business process related to the critical asset (i.e., customers) may be the intake of new customers.

Having identified the key business processes at step 121, the method, according to various embodiments, includes a technological assessment branch, a business process interdependency analysis branch, and a business assessment branch. On the technological assessment branch, the process advances to step 141, where key technological components related to the key business process identified at step 121 are identified. From step 141, the process advances to step 161, where selected key technological components identified at step 141 are evaluated.

On the business process interdependency analysis branch, the process advances to step 171, where an interdependency matrix of the various business processes identified at step 121 is created. The purpose of this analysis is to detect vulnerabilities in process flow by identifying non-compliant, unsecured, suboptimal and/or conflicted links between the business processes of the enterprise by showing, for example, where processes of the enterprise intersect. On the business assessment branch, the process advances from step 121 to step 181, where areas of concern related to the business process identified at step 121 are identified. These areas may include, for example, compliance issues (step 201), data/information issues (step 221), systems issues (step 241), business processes (step 261), and people issues (step 281). Continuing with the banking example, therefore, the compliance issues may include meeting regulatory compliance requirements with respect to the intake of new customer, such as Office of Foreign Assets Control (OFAC) regulations, privacy regulations, U.S. Patriot Act requirements, the Bank Secrecy Act, other banking regulations, etc. Based on the identified areas of concern, the threat profiles for the enterprise related to the business process are created at step 301.

On the basis of, for example, the threat profiles on the business assessment branch, the business process interdependency analysis, and the evaluation of the selected components in the technological assessment branch, risk, compliance, and optimization analyses may be performed at step 321. It should be noted, however, that the risk, compliance and optimization analyses of step 321 may be performed with only one or any combination of the threat profiles on the business assessment branch, the business process interdependency analysis, and the evaluation of the selected components in the technological assessment branch. The output of these analyses may be used in the development of a protection/security strategy at step 341, the development of a compliance strategy at step 361, and the development of an optimization strategy at step 381.

Based on the protection/security strategy (step 341), the compliance strategy (step 361) and the optimization strategy (step 381), a master plan related to the business process may be developed at step 401. Included in the master plan may be an action list, which may be executed at step 421. At step 441, monitoring tools to monitor execution of the items on the action list are implemented. This may include the implementation of monitoring processes and tools to monitor compliance with the protection/security strategy, the compliance strategy, and the optimization strategy. The results of the monitoring process may be output to end-users associated with the enterprise at portals and dashboards, etc., so that the enterprise may take prompt remedial action. The monitoring of these strategies developed as part of the master plan may be an ongoing process, at step 461, and, if problems are found at step 481 as part of the ongoing review, a mitigation response plan may be executed at step 501. Further, because new protection/security, compliance and optimization concerns may arise over time for the enterprise, the process described above may undergo, as signified by step 511, a continual “life cycle” strategic monitoring of the business process so as to permit the development, for example, of a revised master plan in view of new threats, compliance issues and optimization opportunities.

More details regarding the steps of the process of FIG. 7 may be found in the aforementioned published U.S. patent applications.

While several embodiments of the invention have been described, it should be apparent, however, that various modifications, alterations and adaptations to those embodiments may occur to persons skilled in the art with the attainment of some or all of the advantages of the invention. For example, the steps of the processes described above may be performed in different or alternative orders in various embodiments. It is therefore intended to cover all such modifications, alterations and adaptations without departing from the scope and spirit of the present invention as defined by the appended claims.

What is claimed is:

1. A computer-assisted method for generating one or more reusable software components that can be invoked by an automated business process to make the automated business process compliant with a regulation, comprising:
analyzing a document containing the regulation to extract use case information and business rules for a sub-process that complies with the regulation;
developing the reusable software component for the sub-process based on the use case information and business rules; and
storing the reusable software component in a repository such that the reusable software component is invokable by the automated business process.

2. The computer-assisted method of claim 1, further comprising:
identifying one or more object classes for the sub-process; and
generating one or more activity diagrams for the sub-process, and wherein the step of developing the reusable software component includes developing the reusable software component based on the one or more object classes and the one or more activity diagrams.

3. The computer-assisted method of claim 2, further comprising generating one or more class diagrams for the sub-process, and wherein the step of developing the reusable software component includes developing the reusable software component based on the one or more class diagrams.

4. The computer-assisted method of claim 1, further comprising developing user interfaces for the sub-process.

5. The computer-assisted method of claim 1, wherein developing the reusable software component includes:
identifying partner links to access external processes and data sources;
identifying message structures to define input and output documents for the reusable software component; and
creating steps for carrying out the sub-process.

6. The computer-assisted method of claim 5, wherein developing the reusable software component further includes creating web services interfaces.

7. The computer-assisted method of claim 1, further comprising modifying the reusable software component based on modifications to the regulation.

8. The computer-assisted method of claim 1, wherein the regulation includes at least one of: a federal regulation; a federal statute; a state regulation; a state statute; a local ordinance; or a business policy.

9. The computer-assisted method of claim 1, wherein the automated business process includes a resilient automated business process.

10. The computer-assisted method of claim 1, wherein analyzing the document includes:
identifying operational impacts on an enterprise imposed by the regulation;
identifying organizational impacts on the enterprise imposed by the regulation.

11. The computer-assisted method of claim 1, wherein analyzing the document includes using templates and worksheets to reduce the document to functional sections.

12. A computer-assisted method for generating one or more reusable software components that can be invoked by an automated business process to make the automated business process compliant with a regulation, comprising:
analyzing a document containing the regulation to identify process flows and rule logic for a sub-process that complies with the regulation;
developing the reusable software component for the sub-process based on the use case information and business rules; and
storing the reusable software component in a repository such that the reusable software component is invokable by the automated business process.

13. The computer-assisted method of claim 12, further comprising modeling the process flows using semantic analysis modeling tool.

14. The computer-assisted method of claim 13, further comprising modeling the rule logic using a semantic analysis rules engine tool.

15. The computer-assisted method of claim 14, further comprising:
determining integration points for the sub-process; and
identifying security requirements for the sub-process.

16. The computer-assisted method of claim 12, further comprising developing user interfaces for the sub-process.

17. The computer-assisted method of claim 12, wherein developing the reusable software component includes:
identifying partner links to access external processes and data sources;
identifying message structures to define input and output documents for the reusable software component; and
creating steps for carrying out the sub-process.

18. The computer-assisted method of claim 17, wherein developing the reusable software component further includes creating web services interfaces.

19. The computer-assisted method of claim 12, further comprising modifying the reusable software component based on modifications to the regulation.

20. The computer-assisted method of claim 12, wherein the regulation includes at least one of: a federal regulation; a federal statute; a state regulation; a state statute; a local ordinance; or a business policy.

21. The computer-assisted method of claim 12, wherein the automated business process includes a resilient automated business process.

22. The computer-assisted method of claim 12, wherein analyzing the document includes:
identifying operational impacts on an enterprise imposed by the regulation;
identifying organizational impacts on the enterprise imposed by the regulation.

23. The computer-assisted method of claim 12, wherein analyzing the document includes using templates and worksheets to reduce the document to functional sections.

24. An automated business system comprising:
a repository for storing one or more reusable software components, each reusable software component having code for implementing performance of a sub-process to comply with one or more regulations;
a business process engine for executing a business process routine that invokes one or more of the reusable software components; and
a rules engine in communication with the business process engine and the repository for calling one or more of the reusable software component from the repository and delivering to the business process engine.

25. The system of claim 24, wherein one or more regulations include at least one of: a federal regulation; a federal statute; a state regulation; a state statute; a local ordinance; or a business policy.

26. The system of claim 24, wherein the business process engine is for executing a BPEL-coded business process.

27. The system of claim 24, wherein the reusable software components stored in the library are updated based on changes to the one or more regulations.

28. A computer system for generating one or more reusable software components that can be invoked by an automated business process to make the automated business process compliant with a regulation, comprising:
a modeling module for identifying and creating object classes for a sub-process that complies with the regulation;
a semantics analysis module for generating one or more activity diagrams for the sub-process; and
a business process code generator module for generating business process code for the sub-process based on the object classes and the one or more activity diagrams.

29. The system of claim 28, wherein the business process code include BPEL code.

30. The system of claim 28, wherein the regulation include at least one of: a federal regulation; a federal statute; a state regulation; a state statute; a local ordinance; or a business policy.
